(19) United States
(12) Patent Application Publication
(10) Pub. No.: US 2017/0243149 A1
(43) Pub. Date: Aug. 24, 2017

(54) RANKING SYSTEM

(71) Applicant: Nigel Luke JOHNSTON, Manly (AU)

(72) Inventor: Nigel Luke JOHNSTON, Manly (AU)

(21) Appl. No.: 15/500,060

(22) PCT Filed: Jul. 28, 2015
(86) PCT No.: PCT/AU2015/000443

§ 371 Date: Jan. 29, 2017

Related U.S. Application Data
(60) Provisional application No. 62/029,728, filed on Jul. 28, 2014.

(51) Int. Cl. G06Q 10/06; G06Q 30/06

(52) U.S. Cl. CPC G06Q 10/06393; G06Q 30/0605

(57) ABSTRACT

A method of facilitating a stakeholder to engage in business to business trading in goods or services; said method comprising attributing a merit based ranking/score to each stakeholder.

### TECHNICAL FIELD

The present invention relates to a trading portal system with a ranking system and more particularly but not exclusively to a ranking system for use in association with the trading portal system and more particularly a business to business trading portal system. Also disclosed is an infrastructure and an engine for constructing and implementing a supply chain monitoring and analysis system.

### BACKGROUND

Portals to allow access to information about suppliers for buyers are known in the art. Dun and Bradstreet specializes in the supply of financial information, and other sites such as Hoovers allows users to assess business performance typically from information supplied as part of a public company audit report.

However, customers making trading relationship or purchase decisions typically deal with companies that are not publicly traded or where financial reporting information alone is not a full representation of a suppliers merit for the buyers or partners needs.

Alibaba is an example of a multi industry, internationally accessible business information and trading portal. However a key limitation of this service is that the quality of the companies listed in the portal is measured by the company's membership status. Typically companies that pay more in membership fees receive better visibility and prominence to prospective partners and buyers. This approach has questionable value in helping the portal visitor to determine the value of the supplier for a given product application or service.

Alibaba has filed many patent applications including, for example, US20130275269 A1 and U.S. Pat. No. 8,504,563 B2. However, these citations do not disclose what may broadly be determined merit based ranking within a trading portal environment.

Ranking has been carried out in the corporate credit assessment field wherein rankings are provided as a service independent of a trading portal environment. Broadly these rankings have not been merit based in the sense meant in the present application—which is to say such rankings have relied on subjective opinion in large part i.e. what is a supplier's view of the credit worthiness of an entity with which it has dealt either directly or indirectly. To the extent such rankings are not classified as merit based in the present application and, in any event, it is noted that such rankings are typically only performed with respect to a single parameter or at least with respect to a dominant parameter to the substantial exclusion of all others—see for example US2013/0031105 to Stibel, assigned to Credibility Corp discloses an automated ranking system wherein the primary information source for determining ranks is a trade reference—either first rank (meaning the trade reference has directly dealt with the entity being ranked) or second or later ranked (meaning there is only an indirect relationship between the trade reference and the entity being ranked). Broadly this citation amounts to no more than automation of credit reporting activity pre-Internet. A report based substantially or entirely on a credit reference is a very narrow way of seeking to ascertain the likely experience that one might have in dealing with a supplier.

The described invention is designed to address these issues.

It is an object of the present invention to address or at least ameliorate some of the above disadvantages or provide a useful alternative.

### Notes

The term “comprising” (and grammatical variations thereof) is used in this specification in the inclusive sense of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

### SUMMARY OF INVENTION

### Definitions

Merit Based: In this specification, “merit based” means an objective assessment has been carried out at a comparison based on numerically determined or determinable parameters has been made.

Live Update: In this specification, “Live Update” means a change in a parameter at a first location is communicated to a second location quickly. In a preferred form the communication takes place in close to real time. Preferably the communication takes place in real time. In a particular preferred form the change is digitised prior to transmission to the remote location where, in at least some embodiments, it may need translational conversion for presentation or assimilation into the recipient system. In a particular preferred form there is a direct feed of information from the first location to the second location.

Embodiments of the present invention seek to facilitate world trade moving away from the established method of sourcing suppliers where they are ranked purely on the membership contributions to various platforms with a view to providing improved transparency and reliability in decision making in the context of B2B supply systems.

Embodiments also seek to provide an infrastructure for facilitating the objective assessment and a methodology for the use of that infrastructure.

Accordingly, in one broad form of the invention, there is provided a Business to Business trading portal system which has a plurality of stakeholders associated therewith; said system incorporating an active merit based stakeholder ranking system wherein each stakeholder is given a ranking/score by said system; said ranking/score calculated on a continuous basis for each stakeholder based on information elements received by said system; the ranking indicating a figure of merit for a given stakeholder relative to each other stakeholder participating in the system.

Preferably trading includes placing at least a first stakeholder and a second stakeholder in contact with each other for the purpose of trading a specified good or service made available to the stakeholders on the trading portal system.

Preferably trading further includes facilitating a trade in a specified good or service made available to the stakeholders on the trading portal system.

Preferably trading further includes closing a trade in a specified good or service made available to the stakeholders on the trading portal system.

Preferably the stakeholders are separated into groups and a ranking relevant to that group is calculated for each member of that group against other members of that group.

Preferably the stakeholder can be a supplier; a buyer; a supply chain member; a third party contributor such as an auditor or inspection body or financial assessor or insurance company or logistics company.

Preferably a group can consist of one or more of the stakeholders.

Preferably the stakeholders have a direct feed for supply of information elements to the system.

Preferably the information elements can include reference to; ISO certification data which can be optionally can be automatically verified with an ISO body; financial data.

Preferably the data feed is from a portable or mobile digital device.

Preferably data elements are fed by way of a unidirectional data feed.

Preferably data elements are fed by way of a bidirectional data feed.

Preferably said data elements are communicated via a network protocol such as TCP/IP wherein data is transmitted in the form of packets.

Preferably each packet includes a header portion and an associated data payload portion.

Preferably each packet is routed to its addressed destination by means of address lookup tables stored in processing devices located elsewhere on the network.

Preferably said system comprises a full service trading portal providing transaction capability and wherein the data resulting from transactions on or off the portal are used as additional merit based information to formulate the ranking/score.

Preferably said ranking/score is derived at least in part by onsite assessments benchmarked to international standards.

In a further broad form of the invention, there is provided a computer readable media incorporating code which, when executed by a digital data processing system, implements the above system.

In yet a further broad form of the invention there is provided a method of facilitating a stakeholder to engage in business to business trading in goods or services; said method comprising attributing a merit based ranking/score to each stakeholder.

### BRIEF DESCRIPTION OF DRAWINGS

FIG. 1 illustrates main components of the example embodiment

FIG. 2 illustrate an example system of grouping and weighting of supplier data in the example embodiment

FIG. 3 illustrates an example of a supplier score using the example embodiment

FIG. 4 is a block diagram of the system in a specific use scenario

FIG. 5 is a block diagram of a data processing implementation of a first example of the system of FIG. 4

FIGS. 6 to 10 are screenshots from the system of FIG. 5

FIG. 11 is a block diagram of a further example of the system,

FIG. 12 is a block diagram of a particular implementation utilising geographically separated digital input devices.

### DESCRIPTION OF EMBODIMENTS

### First Preferred Embodiment

Method of Operation

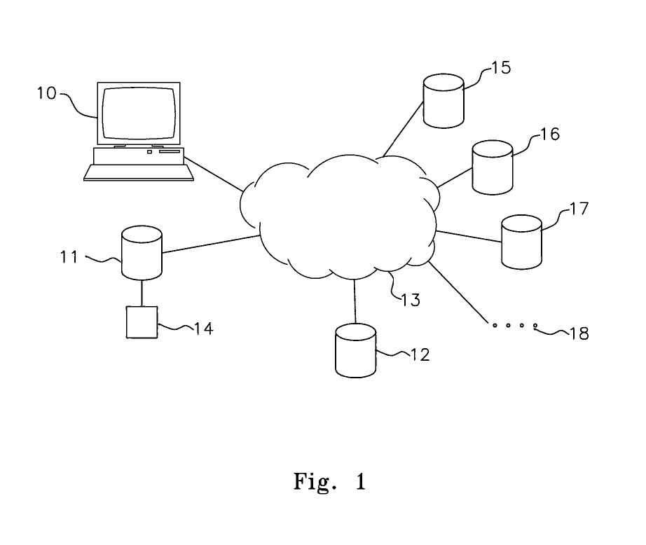

FIG. 1 shows the main components of the example embodiment. A customer 10 wishes to find and evaluate an appropriate supplier 11 using a verification and grading service 12. The service 12 verifies data 14 supplied by the supplier 11 and gives the customer 10 a score based on their independent verification and assessment of the data supplied by the supplier 14 with third parties 15 16 17 18. For example a supplier 11 could supply data 14 that asserts that they are ISO compliant. The service 12 could check that the company is indeed certified for specific ISO standards by accessing ISO certification records 16. Customer references asserted by the supplier 14 could be checked with the references themselves 17. Assertions 14 about the suppliers trading partners and members of their own supply chain could be verified and checked with those supply chain members 15. The same could be done for any number of valuable decision support business metrics 18 asserted by the supplier 14.

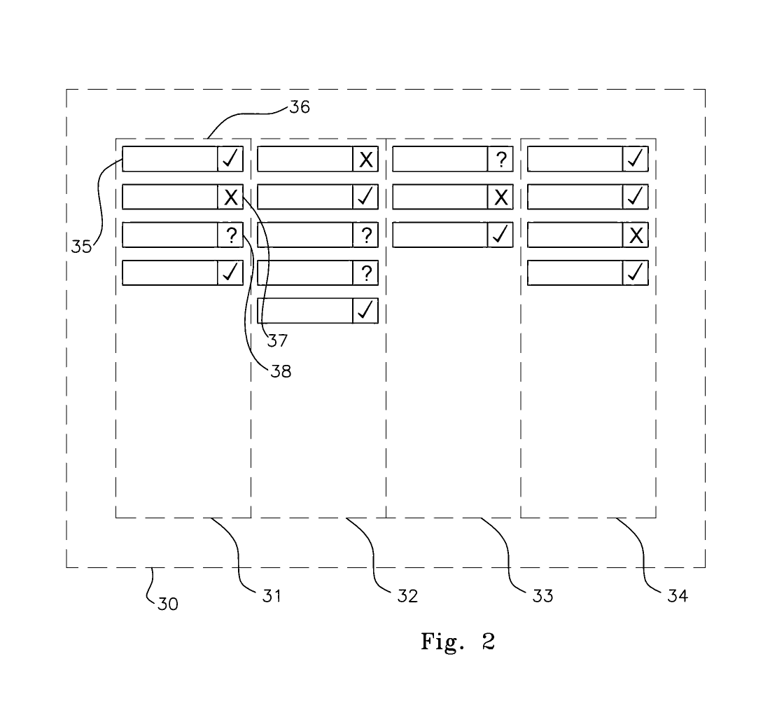

FIG. 2 discloses how data supplied from the supplier is grouped and weighted using the example embodiment. Data supplied by the supplier 30 is grouped into categories 31 32 33 34 to allow the merit of each datapoint supplied by the supplier to be analysed and valued in terms that are of importance to the buyer. In this example embodiment the categories of data include compliance 31 which relates to the standards reached and maintained by the supplier and or the products and services it supplies. Another category could be performance 32 relating but not limited to information about the companies reputation amongst customers and or sales figures. Another category could be capability 33 relating to factors such as production capacity and or delivery reliability. Another category 34 could related to the quality of companies in the suppliers own supply chain. This information could be used to determine the quality of the supplier by their verifiable trading relationships with other known members of the service and portal.

Data points and assertions made by the supplier in each category are checked and verified. Also data points are ranked and prioritised so that references data that is quoted by the supplier that has more importance than other data is given a higher value and priority in the list of data points associated with each category. As each datapoint is checked, that data is tagged as having passed 36 or not passed 37 verification.

In some cases certain key metrics are expected in a particular industry or type of business. For example ISO certification may be required for a supplier of heavy industry machinery. If expected metrics are not supplied by the supplier then that datapoint is marked as not supplied 38 and is included in the evaluated score for the supplier in that category.

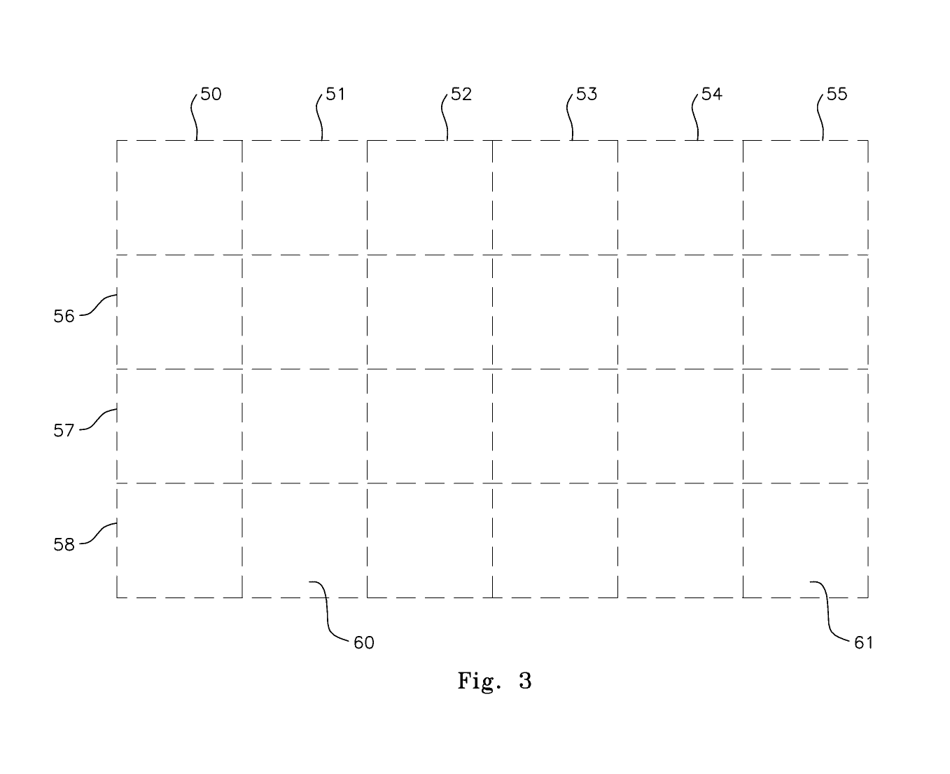

FIG. 3 shows an example evaluation score to be presented to a buyer using the example embodiment. The scoring system shows the key evaluation categories 51 52 53 54 used by the system. Each category 51 52 53 54 has a weighted value. For example in this instance if a total of one hundred points 55 are available for a score of the buyer then the system has weighted the categories so that compliance 51 is valued more highly than the quality of the suppliers supply chain 54 for example. All the possible weighted points for each category will total the maximum number of points available from the scoring system.

A series of internal measurement and analysis tools gives the supplier a relative score 57 based on their supplied data and the results of the data verification. In this case a relative score out of a possible maximum five is assessed.

A weighted score 58 in points can be calculated by multiplying the category weighting 56 by the score 59 and dividing by the maximum score possible 57. In one example a suppliers weighted score would equal thirty two points 60 if the forty total possible category points is multiplied by the score 59 and then divided by the total score possible 57 namely five.

When all the categories are calculated in a similar fashion the supplier would receive a weighted score of fifty nine points 61 out of a possible one hundred points.

### Alternative Embodiments

The example embodiment uses four specific categories of grouped data supplied by the supplier and weighted in a specific way by the verification and grading service. An alternative embodiment could use any number of category grouping and weigh those categories in any way. However typically, the category grouping and weighting of importance is typically defined by known industry and business standards and expectations.

The example embodiment shows a scoring system that utilizes one hundred points to demonstrate the relative value of different categories of evaluated data and an in category scoring system of a relative score out of a possible five. The category score is calculated by multiplying the in-category score to the weighted score of the category. An alternative embodiment could use any relative score system that allows the evaluation to measure the verified value of data within a category and then weights the relative importance of each category to achieve a balanced total score.

In Use

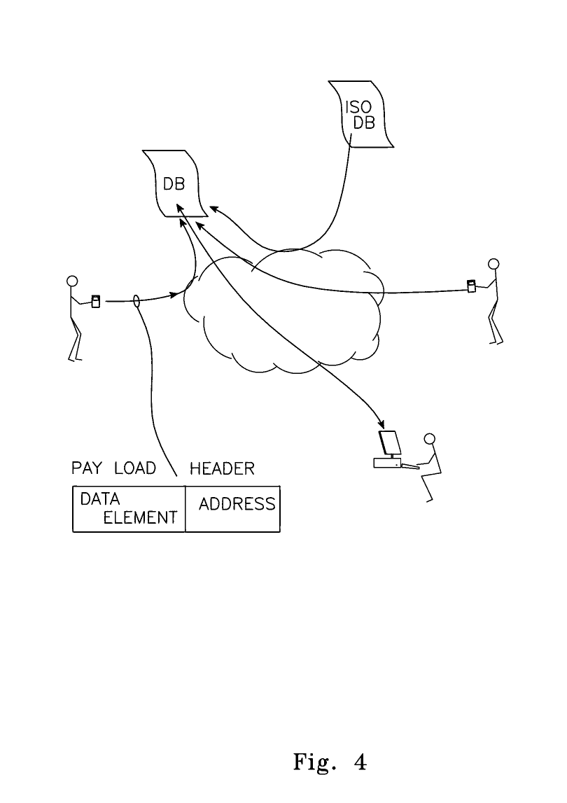

With reference to FIG. 4, various preferred use scenarios will now be described:

In the B2B promotional sector there are various levels of advertising platforms i.e. directories, portals, trading platforms. Directories typically list the basic information with no real features for engagement, portals list more comprehensive information about suppliers and their products and provide features for communication and ecommerce trading platforms provide comprehensive information about the suppliers and their products, product features to communicate, engage and trade samples and trade goods.

Embodiments of the system of the present invention may be applied in the environment of an ecommerce trading platform so it encompasses all features or directories, portals and trading platforms and the infrastructure and methodologies to deliver this system.

Real time: the ranking and scoring on the system of embodiments of the present invention occurs in real time. In preferred forms, it is totally reliant on its computer system and algorithm to process this data to ensure it can provide accurate real time scores and ranks. In order to generate real time scores which are fully responsive to changes made by the suppliers, buyers, supply chain members, third party contributors and related third party bodies preferred embodiments of the system are fully integrated to receive live data changes from all parties.

### EXAMPLES

A supplier may upload information about an ISO certification, which can be verified automatically with that of the body it is certified by.
A customer may upload a reference which could improve the score of the supplier in real time which could lead to an increase in sales for the supplier in real time from another prospective buyer.
A supply chain member may receive an automated financial update from the system of the present invention's third party provider which could either increase or decrease their score/positions which will increase or decrease the supplier who is linked to this supplier which could affect the sales outcome from a buyer all in real time.
Third party contributors i.e. auditors, inspection bodies, financial assessors, insurance companies, logistics companies have direct feeds integrated with the system of the present invention and can use either an online computer device or mobile device onsite or otherwise to input, update or enable live data feeds from their system which will affect the score/rank of the supplier/products/supply chain members at any given time. I/.e. Live audit results uploaded on site of supplier may positively affect a sales outcome due to the live results which affect the score and position of the supplier and or their products. Logistic companies could report that the delivery of the product or goods to the portal was outside of the schedule time which would be also deemed as merit based information which would go towards the score/position of the respective supplier and or product and or even the logistic company score if listed dependent on the outcome.
Third party bodies I.e., ISO certification or ISO accredited bodies. Live feeds can detect changes/validity to the status of either companies/certification bodies and or accredited bodies which will generate a real time change to the score and position of the suppliers and their products.

Mobile Devices

Mobile devices are critical to the success of generating real time scores and rankings. Given the reliance on mobile devices the system of the present invention is fully responsive to work across all devices.

Mobile devices are used by suppliers, buyers (customers), auditors, and inspection bodies, logistics companies etc. to demonstrate evidence of trading information which will affect the score or rank of the supplier in real time which will affect the sales outcome in real time.

e.g. Pre deliver and post delivery images and data which can be used to demonstrate the positive or negative outcome along the production and trading life cycle which will automatically affect the score and position of the supplier and or their products on the platform. Specific example could be to demonstrate that production is on time, goods are at the port, goods received, quality of goods, meeting specification, inline with samples, condition of goods etc.

The system of the present invention provides full payment facilities which allow users to be able to sample and trade goods via the platform. Mobile devices critical for making payment in real time post an inspection of goods to maintain or improve delivery times and efficiencies of trade. The system of the present invention provides Escrow services for buyers and suppliers. The computer system will wait for a positive action from both the buyer and supplier before a payment is made. This payment can be released post image or inspections have been conducted an uploaded into the system by the mobile device or other. The data received from transaction services are feed to the computer system to affect the real time scores/rank of the suppliers and their products listed on the platform.

Algorithm—The score of the product is not confined to 100 and the score of a supplier is also not confined to 100. The drawings do reflect how the data can be: inputted, verified or not inputted across all fields. However the actual scoring is more fluid than fixed. Suppliers can continually add data to improve their score, there is no cap on the amount of product references you can provide, supply chain links or qualification or certifications you can add. Therefore when converting the scores back to five that is dependent on the spread of scores which are within the international standards the applicant has developed. On the supplier side—individual product scores feed into the overall supplier score. On the supplier score it is not as fluid as the product scores however there is no cap on the amount of certifications or qualifications which can be added across fields therefore the points are not capped.

ISO—ISO certifications in some embodiments are a key element for ranking the suppliers in reference to compliance.

In summary a “merit” based ecommerce portal is disclosed. Preferred embodiments comprise not just an advertising portal but rather a full service trading portal providing transaction capability and the data resulting from the transaction on or off the portal are used as additional merit based information. In preferred embodiments some of the most critical real time data is derived from mobile devices and via the transactional facility via the computer system which can significantly affect real time sales decisions.

### Example 1

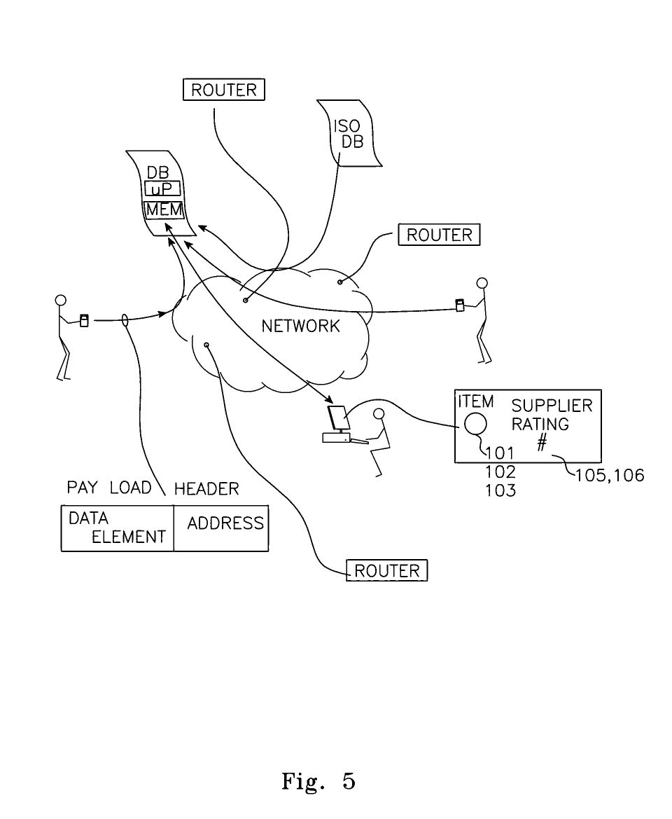

With reference to FIG. 5 onwards a detailed example of an implementation of the trading portal system 100 of the present invention is illustrated by way of selected screenshots. FIG. 5 is a block diagram of the system implemented utilizing a processor and memory and wherein data is transmitted by way of packets over a digital network—each packet comprising a header containing an address portion and a data storage portion associated with the header and containing an information element or a portion thereof for passing from a first location on the network to a second remote location on the network.

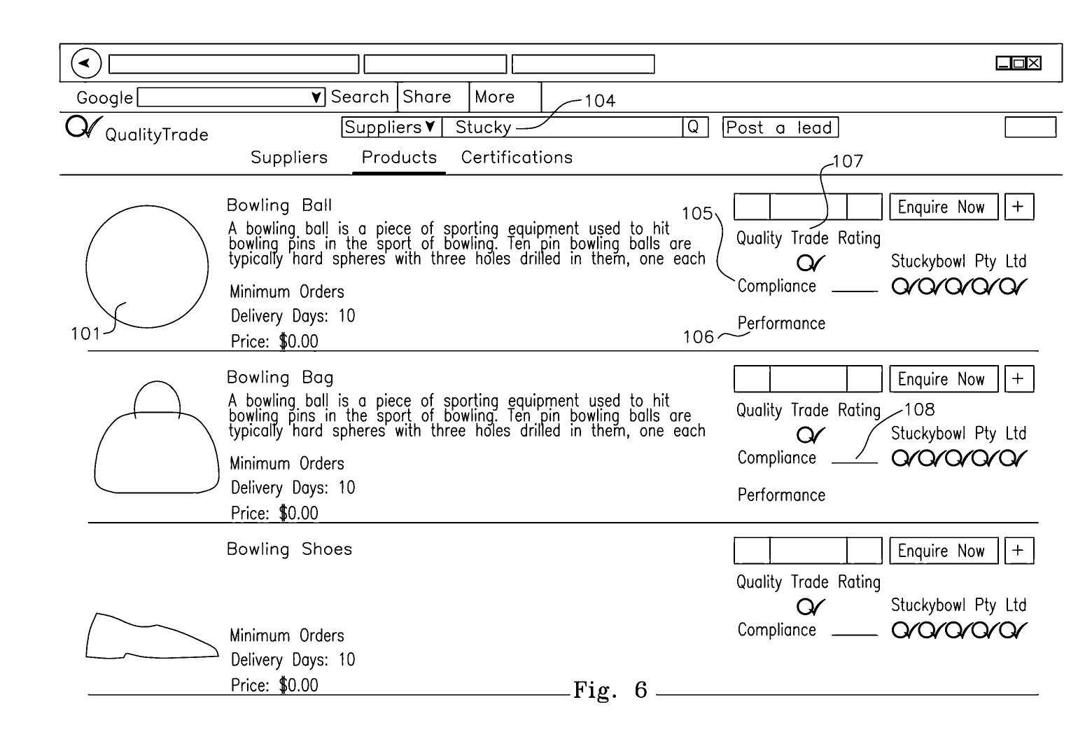

FIG. 6 shows a screenshot illustrating three items 101, 102, 103 which have been brought up from the database by a search on supplier “stucky” denoted 104. The first item 101 is a bowling ball which has associated with it a compliance rating 105 and a performance rating 106 under the general heading quality trade rating 107. It will be observed the compliance rating 105, in this instance, is represented on an analog scale and denotes a relatively high rating compared with a corresponding compliance rating 108 given to second item 102 being, in this instance, a bowling bag. It will be observed that the compliance rating have been performed for individual items from supplier 104.

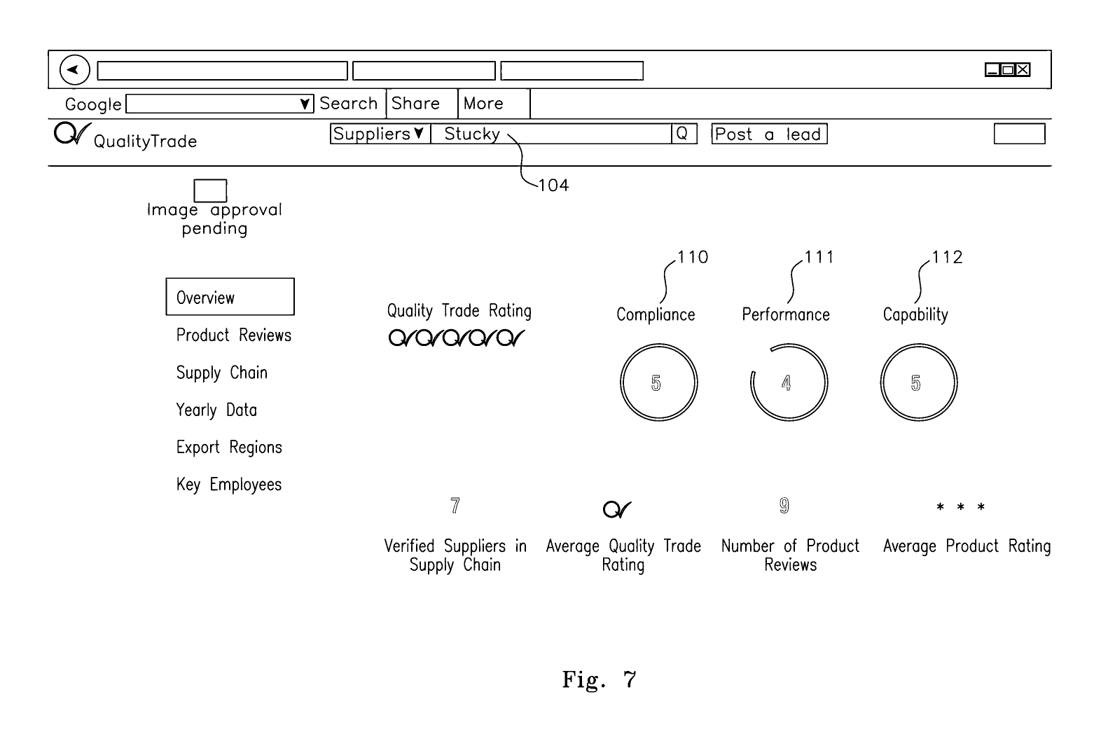

Supplier 104 itself is rated as illustrated in FIG. 7 wherein, in this instance, it is given an overall compliance rating 110 of 5 out of 5; an overall performance rating 111 of 4 out of 5 and an overall capability rating 112 of 5 out of 5.

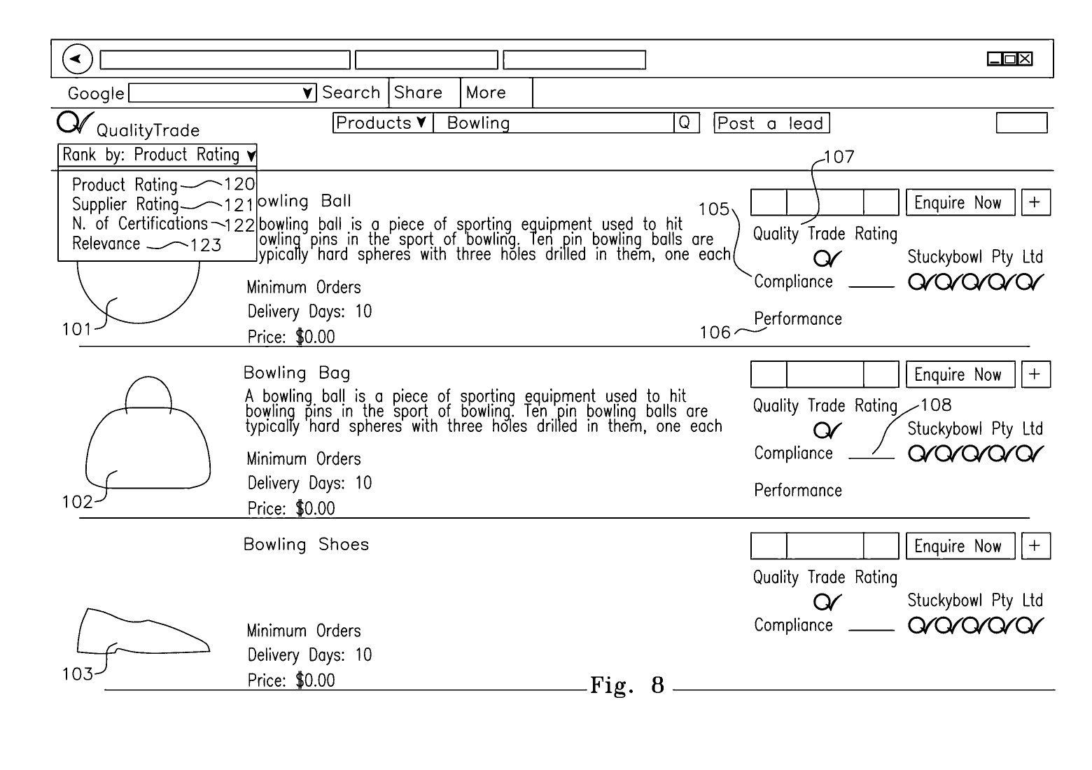

As illustrated in FIG. 8 products sourced on the trading portal system 100 such as products 101, 102, 103 can be rated according to a number of different ratings including product rating 120, supplier rating 121, number of certifications 122 or relevance 123.

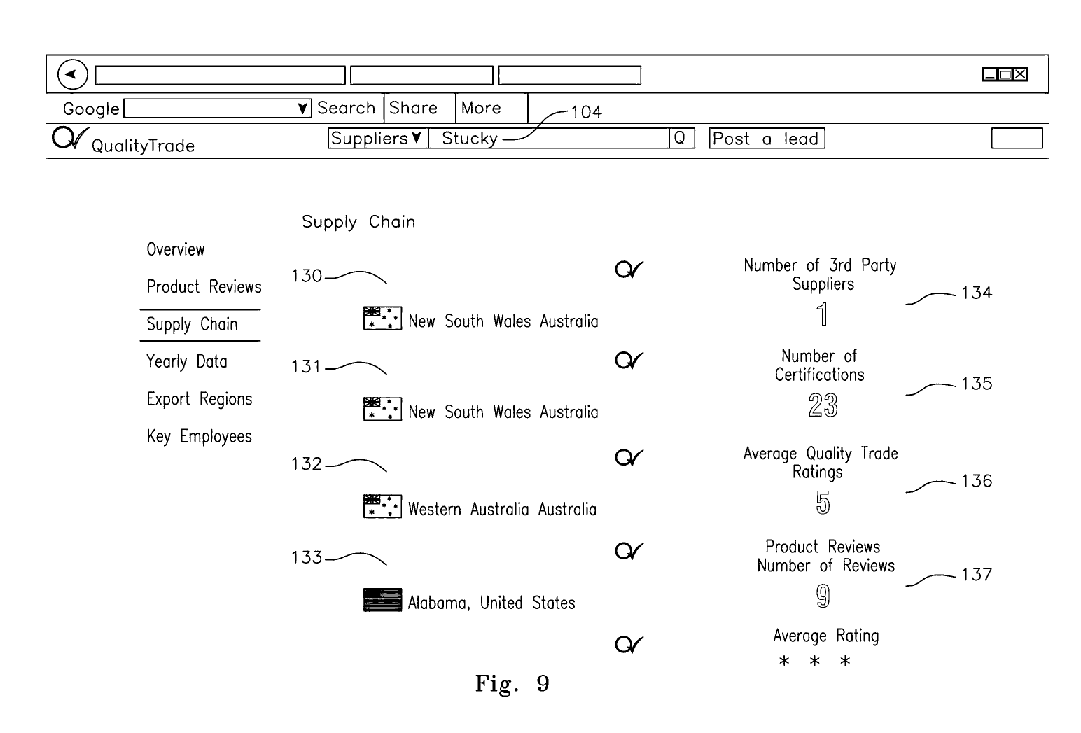

With reference to FIG. 9 a prospective purchaser can “drill down” into further quality rating information concerning a particular product or supplier to the point of obtaining quite granular information as to how any given rating has been constructed including how many entities have contributed to the rating and in what capacity. In this instance FIG. 9 shows that the rating information for supplier 104 is derived from separate, quantified geographic locations 130, 131, 132, 133 and further including the number of third party suppliers 134, number of certifications 135, average quality trade rating 136, and number of product review ratings 137.

It would therefore be observed that quite significant and detailed rating/ranking scores are provided—all of these scores being based on quantified and quantifiable data rather than pure opinion data.

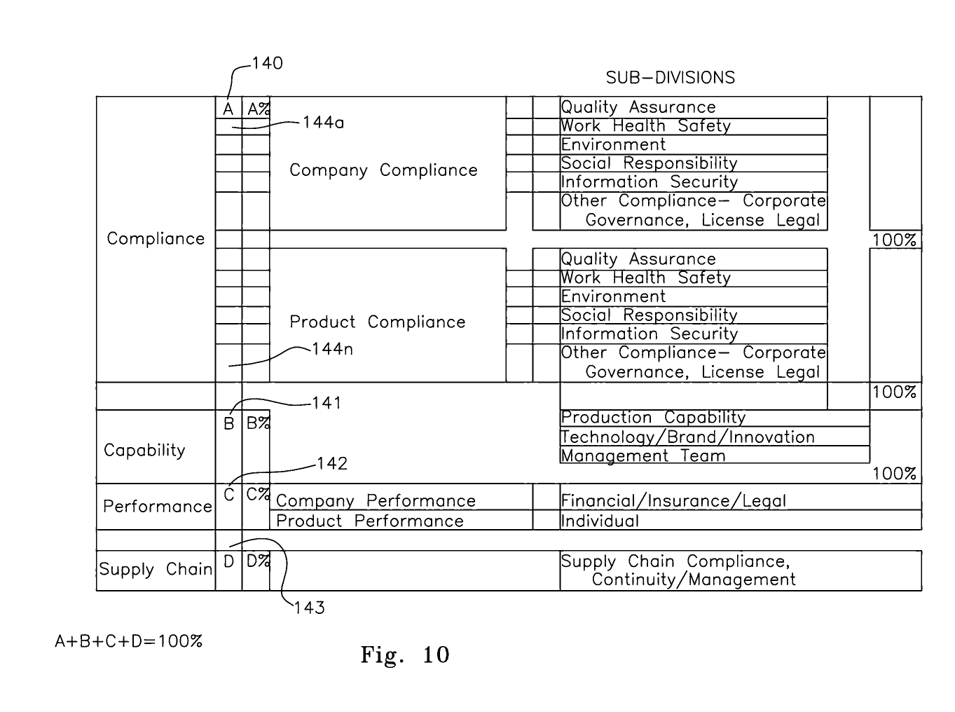

FIG. 10 illustrates a basic spreadsheet format which can be utilised to accord weightings 140, 141, 142, 143, for suppliers within the system 100. The individual components making up each weighting may be few in number or can be generated from a large number of individual information elements 144a-144n.

Broadly stated the system of Example 1 provides a Business to Business trading portal system which has a plurality of stakeholders associated therewith; said system incorporating a quantifiable merit based stakeholder ranking system wherein each stakeholder is given an objectively quantified ranking/score by said system; said ranking/score calculated for each stakeholder based on information elements received by said system; the ranking indicating a figure of merit for a given stakeholder relevant to purchasing decisions by others of said stakeholders participating in said system.

### Example 2

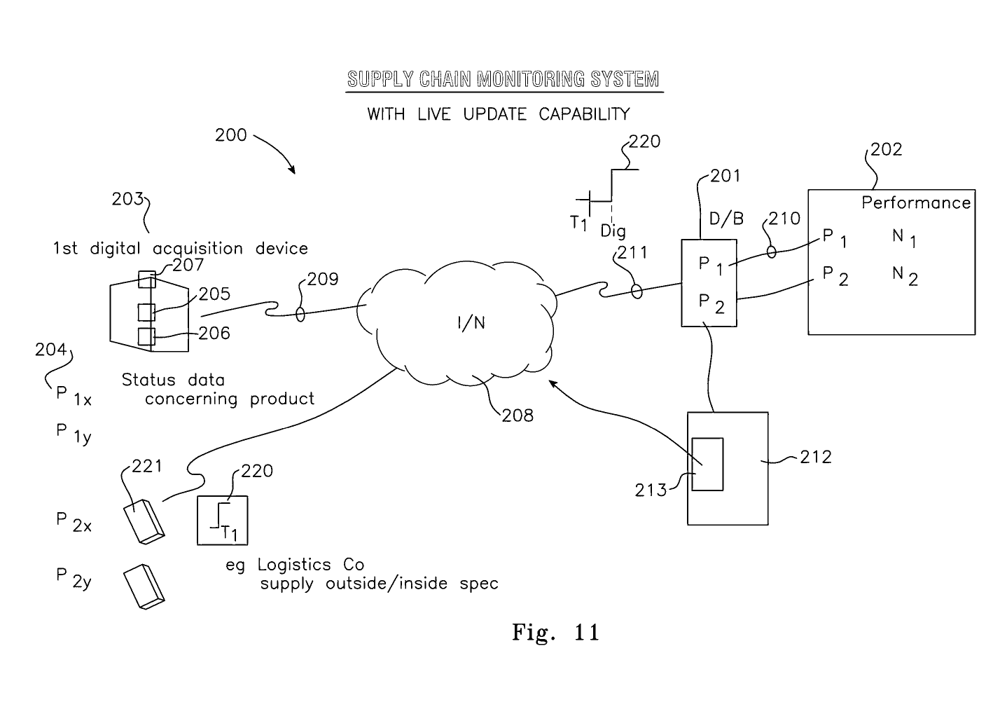

With initial reference to FIGS. 4 and 5 whose content is incorporated herein as part of this example a further example describing a supply chain monitoring system will now be described with reference to FIG. 11.

In this instance a supply chain monitoring system 200 comprises a database 201 in communication with one or more business databases 202 which monitor parameters concerning characteristics of a supplier company. Such parameters may include trading status, parameters relating to liquidity, share price, share price movement over time and other aspects of the “health” of the company in question. Separately a plurality of digital acquisition devices including at least a first digital acquisition device 203 received data related to at least a first product 204 of a supplier company, which company has its status being reported via database 202.

The digital data acquisition device will include at least a processor 205 in communication with a memory 206 and further in communication with a communications module 207. The communications module 207 in a preferred form of incorporates a direct link to database 201 in a particular preferred form via Internet 208. The direct link 209 permits the rapid transition transmission of data concerning the status of at least first product 204 to database 201 whereby both company specific data 210 and product specific data 211 concerning any given product including product 204 associated with its supplying company is supplied to database 201. In a particular preferred form the database 201 communicates with a web server 212 which permits the associated data 210 and 211 to be selectively observed by a search engine 213, for example in the manner described with reference to FIGS. 6 to 10.

In a particular preferred form in the event of a status change represented, in this instance, by step change 220 detected by second digital acquisition device 221 at the time T 1, the step change 220 is communicated via a direct connection over Internet 208 to database 201 and the step change is detected at database 201 at the time T 1+T where T is in the order of no more than seconds in a preferred form from when the step change 220 is first registered on second digital acquisition device 221.

### Example 3

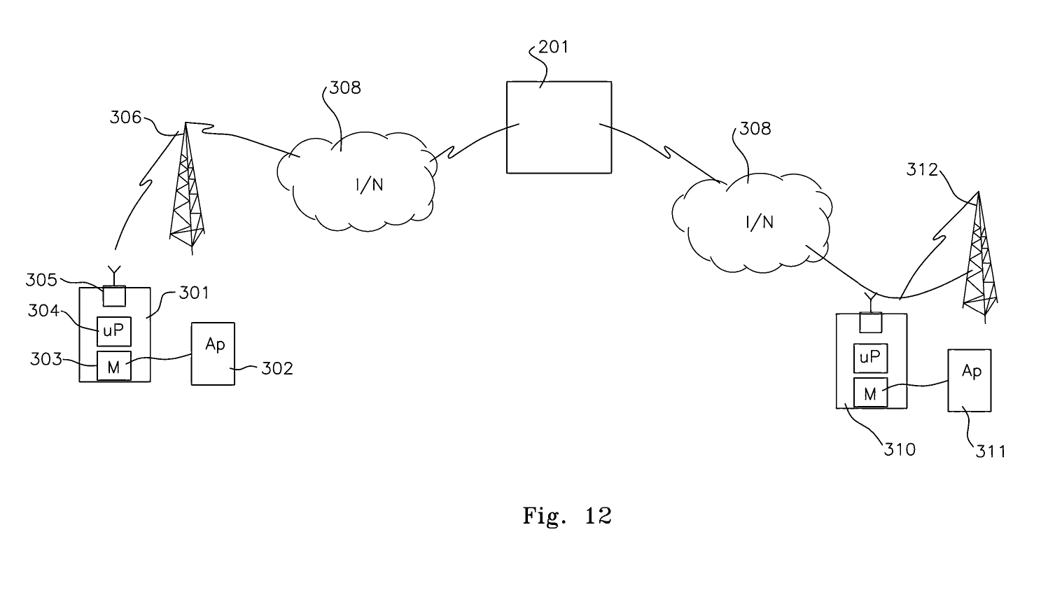

with reference to FIG. 12 database 201 (refer previous example) may receive data from a digital device 301 which is a program (or application) 302 resident in memory 303 and executable by a processor 304 and whose results are communicated via communication model module 305 via mobile phone system 306 and Internet 308 to database 201. Correspondingly, at a geographically separate location there is a further digital device 310 having residence in memory thereon a corresponding application 311 which similarly is communicable via mobile telephone system 312 and Internet 308 to database 201. In a first particular instance the applications allow access by a respective buyer and seller to the Web enabled contents of database 201 and further allow a “matchmaking” capability wherein if a particular buyer has access purchase capacity on a particular day and can match that day with a seller at a geographic please separate location who has a correspondingly mismatched selling capacity for product on the same day then, subject to agreement on price and a match can be made which includes utilisation of an additional parameter, in this case access purchase/sell capacity as a function of a particular day or time period.

In a further example the digital devices hundred and three, 310 can also be used as to assist in an “ready reckoner” function wherein a prospective buyer can utilise a digital device 303 which has access to database 201 to perform and “what if” scenarios on purchasing a particular product and product quantity and product characteristic as a function of price which may vary according to the rated quality of the supplier if purchased from a particular seller whose product is available on database 201. If agreement can be reached then the transaction is completed by communication over geographically separated digital devices 303, 310.

### INDUSTRIAL APPLICABILITY

Embodiments of the present invention can be implemented utilising data processing equipment communicated over distributed network arrangements including local networks and wide area networks including the Internet.

1. A Business to Business trading portal system which has a plurality of stakeholders associated therewith; said system incorporating an active merit based stakeholder ranking system wherein each stakeholder is given a ranking/score by said system; said ranking/score calculated on a continuous basis for each stakeholder based on information elements received by said system; the ranking indicating a figure of merit for a given stakeholder relative to each other stakeholder participating in the system.

2. The system of claim 1 wherein trading includes placing at least a first stakeholder and a second stakeholder in contact with each other for the purpose of trading a specified good or service made available to the stakeholders on the trading portal system.

3. The system of claim 1 wherein trading further includes facilitating a trade in a specified good or service made available to the stakeholders on the trading portal system.

4. The system of claim 3 wherein trading further includes closing a trade in a specified good or service made available to the stakeholders on the trading portal system.

5. The system of claim 1 wherein the stakeholders are separated into groups and a ranking relevant to that group is calculated for each member of that group against other members of that group.

6. The system of claim 1 wherein the stakeholder can be a supplier; a buyer, a supply chain member; a third party contributor such as an auditor or inspection body or financial assessor or insurance company or logistics company.

7. The system of claim 5 wherein a group can consist of one or more of the stakeholders.

8. The system of claim 1 wherein the stakeholders have a direct data feed for supply of information elements to the system.

9. The system of claim 8 wherein the information elements can include reference to financial data and/or ISO certification data which optionally can be automatically verified with an ISO body.

10. The system of claim 8 wherein the data feed is from a portable or mobile digital device.

11. The system of claim 8 wherein data elements are fed by way of a unidirectional data feed.

12. The system of claim 8 wherein data elements are fed by way of a bidirectional data feed.

13. The system of claim 8 wherein said data elements are communicated via a network protocol such as TCP/IP wherein data is transmitted in the form of packets.

14. The system of claim 13 wherein each packet includes a header portion and an associated data payload portion.

15. The system of claim 14 wherein each packet is routed to its addressed destination by means of address lookup tables stored in processing devices located elsewhere on the network.

16. The system of claim 1 comprising a full service trading portal providing transaction capability and wherein the data resulting from transactions on or off the portal are used as additional merit based information to formulate the ranking/score.

17. The system of claim 16 wherein said ranking/score is derived at least in part by onsite assessments benchmarked to international standards.

18. A computer readable media incorporating code which, when executed by a digital data processing system, implements the system of claim 1.

19. A method of facilitating a stakeholder to engage in business to business trading in goods or services; said method comprising attributing a merit based ranking/score to each stakeholder.

20. (canceled)

21. A supply chain monitoring system incorporating live update capability; said system comprising at least a first digital acquisition device which receives status data concerning a product of an at least first entity and communicates that status data via a packet based data transmission system to at least a first storage and comparison system;
at least a second digital acquisition device which receives status data concerning product data of at least second entity and communicates that status data via a packet based data transmission system to the at least first storage and comparison system;
at least a first data feed in communication with at least a first database; the first database storing comparative data in respect of at least a first and a second entity; the at least first data feed communicating comparative data concerning the at least first entity and at least second entity to the at least first storage and comparison system;
the at least first storage and comparison system applying a comparison algorithm to the status data thereby to generate a figure of merit ranking the product of at least the first entity against the product of at least the second entity;
the at least first storage and comparison system applying a comparison algorithm to the at least first data feed thereby to generate a figure of merit ranking the at least first entity against the second entity;
presenting the figure of merit ranking the product on an output display;
presenting the figure of merit ranking the first entity against the second entity on an output display; thereby to permit assessment of quality of product supply and quality of supplier.

22-31. (canceled)
